(19) United States
(12) Patent Application Publication
(10) Pub. No.: US 2005/0051042 A1
(43) Pub. Date: Mar. 10, 2005

(54) One-piece injection-molded or cast silk screen frame

(76) Inventor: Ronald Salisbury, San Diego, CA (US)

Correspondence Address: Steven W. Webb;Law Offices of Steven W. Webb, 655 2nd Street, Encinitas, CA, 92024, US

(21) Appl. No.: 10/656,719

(22) Filed: Sep. 8, 2003

(51) Int. Cl. B41F 15/34

(52) U.S. Cl. 101/127.1

(57) ABSTRACT

An improved screen printing frame is presented that is cast from one piece of plastic material and possesses support ribs to confer additional strength to the structure. The frame is designed to be produced by a low-cost single-mold casting process and to permit the attachment of screens by adhesive means.

### BACKGROUND OF THE INVENTION

This invention relates to rectangular or square screen printing frames and in particular to an improvement in screen printing frame design and manufacture.

Existing rectangular and square screen printing frames are intended to support the screen mesh while maintaining an even strain on the screen at all points when ink is forced through the screen. Uneven screen tension causes uneven printing of the desired image. Hence, a rigid and strong frame is required to obtain the best results, requiring strong and lightweight components.

Typical screens are made out of wood or extruded aluminum hollow tubing side members with rectangular or square cross-sections. Each of these component materials has limitations. Welding the aluminum frames together is expensive and requires relatively thicker metal in the side members, thereby increasing the weight of the screen. Wooden frames must be cut and formed, then connected with fasteners and/or glue. Each frame requires a certain amount of manpower to manufacture from its component parts.

A recurring problem with screen printing frames is that they need to be washed with water regularly between uses. The solid wooden frames can warp or crack after repeated washings. While aluminum does not absorb water, a pinhole in a frame weld will allow water into the hollow frame interior.

Plastic frames are light-weight and low-cost, but a plastic hollow-tube frame is not strong enough to hold the tension on the silkscreen itself and still has to be cut and joined. A plastic screen with an open design and integral bracing members solves the weight and strength problem. Casting the frame in one piece is a low-cost solution.

None of the prior art screen frame devices have this approach, a single-piece injection-mold or casting of rigid material. The present invention differs from the state-of-the-art devices by virtue of its low-cost manufacture, its ease of assembly with the silk screen itself, and its self-drying capability.

### BRIEF SUMMARY OF THE INVENTION

It is an object of this invention to provide a screen printing frame that is low-cost to manufacture.

It is an object of this invention to provide a screen printing frame that is light-weight, strong and durable in use.

It is a further object of this invention to provide a screen printing frame that is low-cost to manufacture.

Further objects of this invention can be discerned by perusing the detailed description, drawings, specifications and claims of this application.

### BRIEF DESCRIPTION OF THE DRAWING

The construction and operation of the invention can be readily appreciated from inspection of the drawings that accompany this application, combined with the detailed specification to follow.

FIG. 1 is a perspective drawing of the preferred embodiment of the invention.

FIG. 2 is a cross-section diagram of the preferred embodiment of the invention.

FIG. 3 is a cross-section of the side of the frame.

FIG. 4 is side view of the invention.

FIG. 5 is a perspective view of an alternative embodiment

FIG. 6 is a bottom view of an alternative embodiment

### DETAILED DESCRIPTION OF THE INVENTION

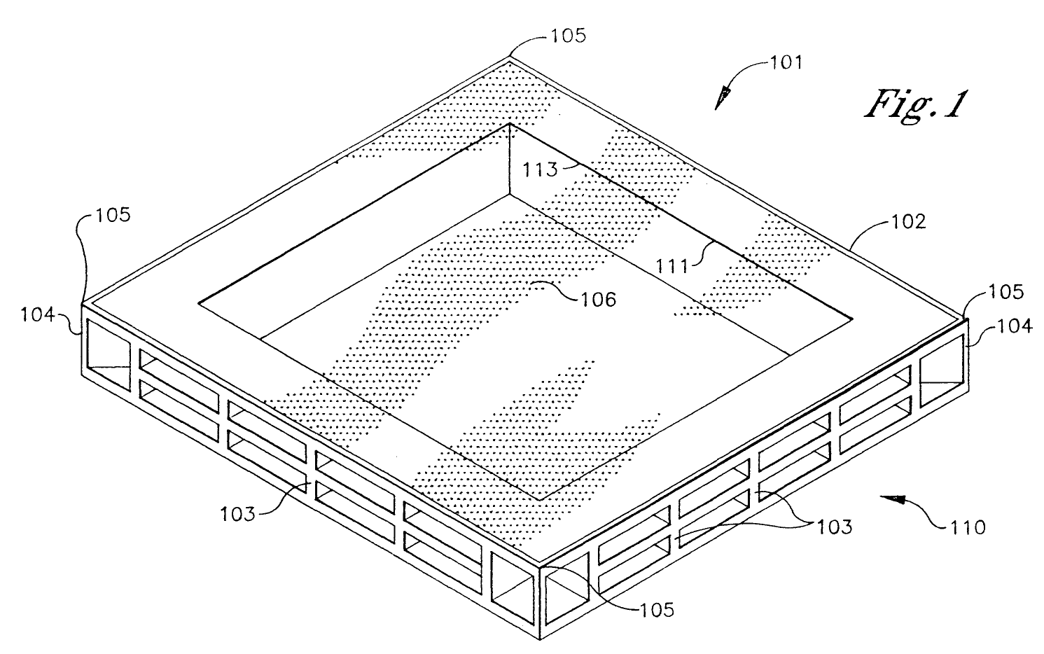

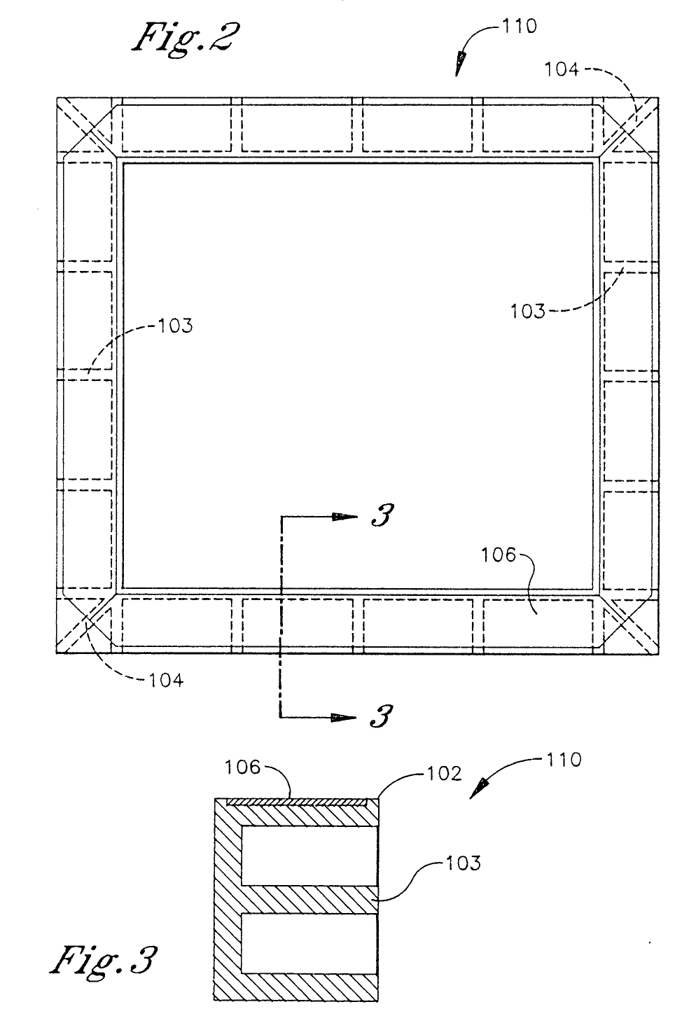

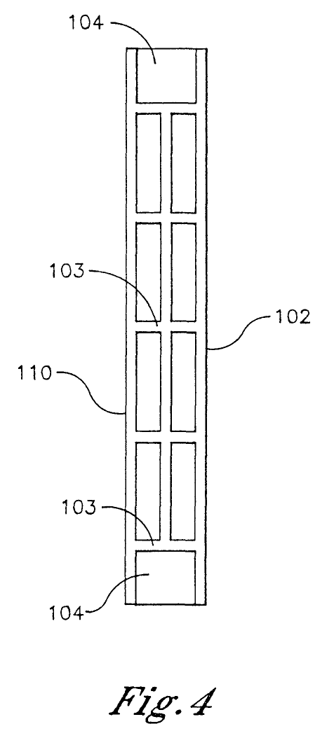

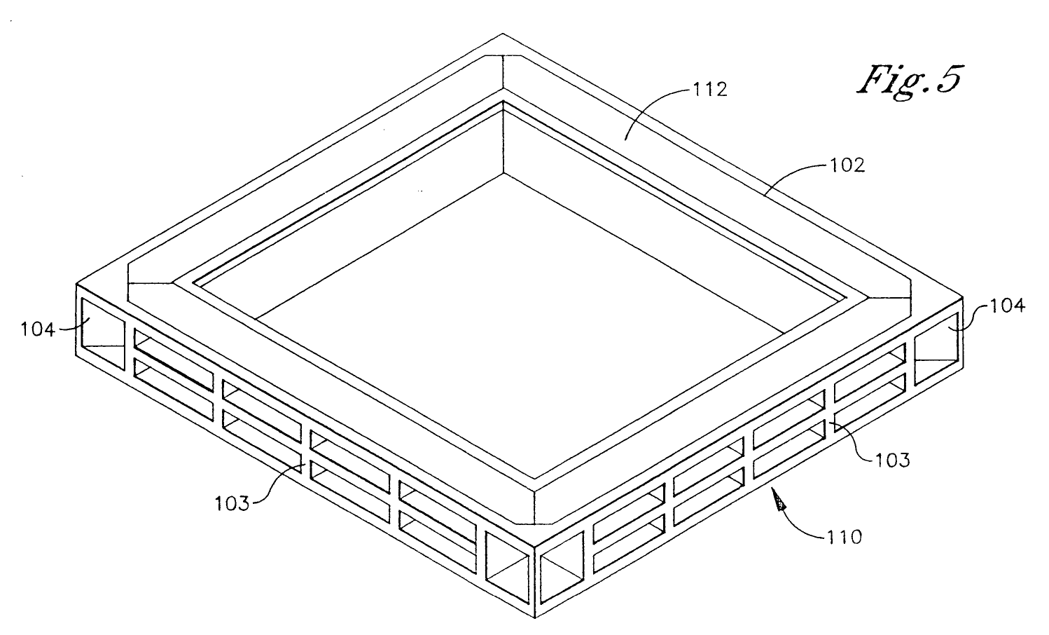

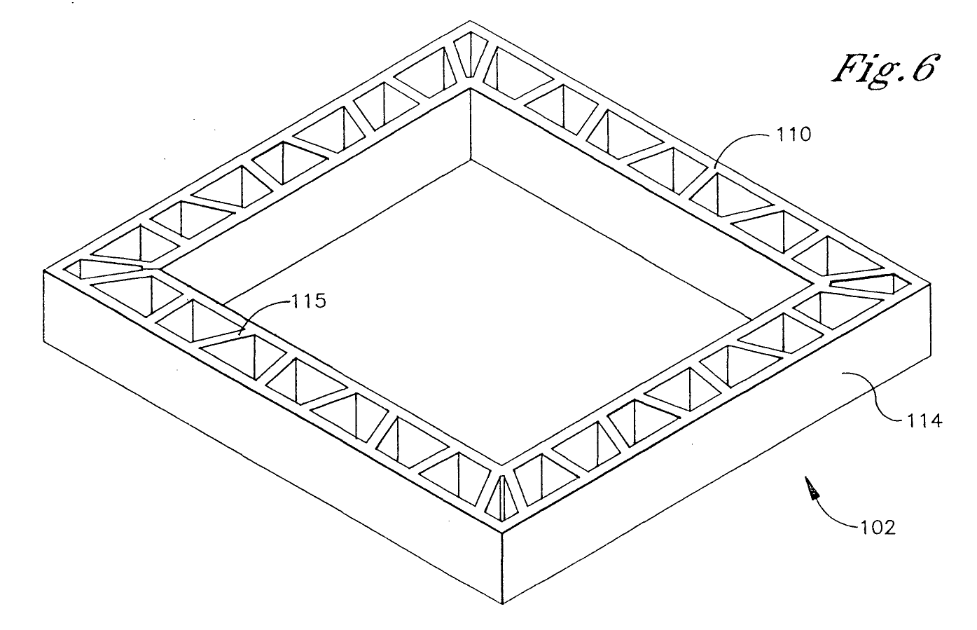

The invention is best described by referring to the preferred embodiment illustrated in the drawing in FIG. 1. Referring to FIG. 1, a one-piece injection-molded or cast screen printing frame (cast frame) 101 is a structure that resembles a picture frame, but the frame itself is not a solid piece of wood or a hollow metal tube. The cast frame 101 is a rectangular structure comprised of a single piece of cast material. The cast frame possesses a top edge 102, a bottom edge 110, an interior edge 111, and a plurality of support ribs 103 which, in the preferred embodiment, are parallel to the top and bottom edges 102,110 of the cast frame 101 and perpendicular to the interior edge 111. In other embodiments, these support ribs 103 could be cast such that they form an angle to the top and bottom edges 102,110. In a particular alternate embodiment, illustrated in FIG. 6, the bottom edge 110 can possess bottom support ribs 115 while the sides 114 and top 102 are solid.

A corner support rib 104 is placed in each corner 105 of the plastic frame 101 as shown in FIG. 1, 2, and 4, and each corner support rib 104 is merged into the one-piece cast frame 101 and the support ribs 103. The corner support ribs are perpendicular to the support ribs 103 and the top 102 and bottom edges 110. They run from the apex of the corner 112 to the angle 113 of the interior edge 111.

The silk screen fabric 106 is fixedly attached to the top surface of the cast frame. The silk screen fabric 106 can be made from a number of different materials including polyester and metal.

The cast frame 101 itself can be made of several materials, including nylon, styrene, polypropylene, or metal. Metals include aluminum. The preferred embodiment of this invention is a cast plastic frame 101 and a polyester silk screen fabric 106 with the silk screen fabric 106 attached to the frame 101 by means of adhesive.

A further alternative embodiment of this invention, where the plastic used for the cast frame 101 will not hold the silk screen 106 adequately, the silk screen 106 being attached by means of adhesive, is to add an aluminum or steel liner 112 to the top edge 102 of the cast frame 101, the liner fixedly attached to the top edge 102 of the cast frame 101 by mechanical means, by being cast into the top edge 102 when the cast frame 101 is made, or by means of adhesive, the silk screen fabric 106 then connected fixedly to the liner by means of adhesive.

Another alternative embodiment of the cast frame 101 is where the frame sides 114, inside and outside, are bowed in an outwards direction slightly to give the cast frame 101 added strength when the silk screen fabric 106 is stretched over it. The bowed shape confers strength and stability to the sides 114 when under the stress of the stretched silk screen fabric 106.

While the foregoing describes a preferred embodiment and several alternative embodiments, variation on this design and equivalent designs may be resorted to in the scope and spirit of the claimed invention.

1. A screen printing frame and screen,
the screen printing frame comprised of a single piece of material, the single piece of material possessing a rectangular shape, the rectangular shape comprised of four sides, the sides possessing four interior edges, a top edge, four outside edges, a bottom edge and a plurality of support ribs,
the screen comprised of a fabric, the screen stretched over the top edge of the screen printing frame, the screen fixedly attached to the screen printing frame.

2. The screen printing frame and screen as in claim 1, where the plurality of support ribs is disposed between and parallel to the top edge and the bottom edge and perpendicular to the interior edge,
the plurality of support ribs merged solidly into the material of the interior edge and running longitudinally down each side of the rectangular shape,
the rectangular shape possessing four corner support ribs, the corner support ribs each merging solidly into the material of the top edge, the bottom edge, the support ribs, and the interior edge, the corner support ribs extending from the apexes of the corners of the rectangular shape in a straight line to the interior angle of the inside edge, the corner support rib perpendicular to the top edge, bottom edge, and all of the support ribs.

3. The screen printing frame and screen as in claim 1, where the plurality of support ribs is disposed in the bottom edge, the interior edges, top edge and outside edges being solid, the plurality of support ribs merging solidly into the interior and outside edges and the top edge.

4. A screen printing frame and screen as in claim 1 where the screen is fixedly attached to the screen printing frame by means of adhesive connecting the screen to the top edge of the screen printing frame.

5. A screen printing frame and screen as in claim 1 where the top edge of the screen printing frame is inlaid with a metal liner, the metal liner attached fixedly to the top edge of the screen printing frame, the upper surface of the metal liner flush with the top edge of the screen printing frame, the screen attached fixedly to the metal liner.

6. A screen printing frame and screen as in claim 1 where the four sides of the screen printing frame are bowed outwards slightly to confer greater strength to the screen printing frame.

7. A screen printing frame and screen as in claim 1 where the single piece of material is produced by casting.

6. A screen printing frame and screen as in claim 1 where the single piece of material is produced by injection molding.
